(19) United States
(12) Patent Application Publication
(10) Pub. No.: US 2025/0069399 A1
(43) Pub. Date: Feb. 27, 2025

(54) COMPUTER-IMPLEMENTED METHOD AND SYSTEM FOR IDENTIFYING OBJECTS IN AN ENVIRONMENT

(71) Applicant: Scalpel Ltd., Essex (GB)

(72) Inventors: Yeshwanth PULIJALA, London (GB); Shahnawaz AHMED, London (GB)

(73) Assignee: Scalpel Ltd., Essex (GB)

(21) Appl. No.: 18/289,889

(22) PCT Filed: May 5, 2022
(86) PCT No.: PCT/GB2022/051150

§ 371 Date: Nov. 7, 2023

(30) Foreign Application Priority Data
May 7, 2021 (GB) 2106552.9

(51) Int. Cl. G06V 20/52; G06T 7/20; G06T 7/50; G06V 10/60; G06V 10/764; G06V 20/70

(52) U.S. Cl. CPC G06V 20/52; G06T 7/20; G06T 7/50; G06V 10/60; G06V 10/764; G06V 20/70; G06V 2201/07

(57) ABSTRACT

A computer-implemented method for identifying objects in an environment is disclose. The method comprises: receiving image data representing the environment from one or more cameras; analysing the image data to detect objects in the environment and for each detected object, assigning a preliminary identification label and confidence factor to the object; receiving environmental data from one or more environmental sensors, analysing the environmental data to detect classification indicators and for each detected object, modifying the confidence factor assigned to the object if a classification indicator correlates with the preliminary identification label and/or using one or more measurement sensors to measure one or more physical characteristics relating to a set of objects at a predefined location within the environment, the set of objects being included within the detected objects, and, for each measured physical characteristic, modifying the confidence factor associated with each object in the set if the physical characteristic corresponds to an expected value for the objects found at the predefined location; and for each detected object, identifying the object by associating with it a final identification label equal to the preliminary identification label if the confidence factor assigned to the object meets a predefined criterion.

### FIELD OF THE INVENTION

The invention relates to a computer-implemented method for identifying objects in an environment and to a corresponding system and computer-readable medium.

The invention also relates to a computer-implemented method for accounting for the presence or absence of items used in a procedure.

### BACKGROUND

The ability to identify objects in an environment using a computer system, in which a computer processes data captured by one or more sensors, is clearly helpful in a multitude of applications. Example industrial applications include sorting, inventory management, machining, quality management, maintenance and packaging.

Existing techniques suffer from a number of drawbacks. For example, the system may not be able to identify objects within the environment to an adequate degree of confidence to reliably identify them for certain applications. This may occur, for example, if the object is partially overlaid by another object or if a camera's view of the object is partially obscured by another object.

One application where identification of objects in an environment using a computer vision system is useful and that is particularly relevant to the context of this application is in accounting for the presence or absence of items used in a procedure. One example of such a procedure might be maintenance work on a vehicle such as a car or plane. Being able to account for the presence or absence of the tools used in the procedure is beneficial to ensure that no tools are left in the vehicle which could cause damage or injury as well as financial loss. Similarly, being able to account for the components used in the procedure and/or components removed from the vehicle during the procedure which must be refitted before the end of the procedure is clearly critical to the success of the procedure as well as for reasons of avoiding damage to the vehicle or injury.

Another example of a procedure where accounting for the presence or absence of objects is particularly useful is in surgical operations. It is clearly essential to avoid injury and/or the need for further operations to ensure that all surgical instruments, dressings and other items used in a surgical operation are present at the end of the operation so that it can be ensured that nothing has been left in the patient.

### SUMMARY

In accordance with one aspect of the invention, there is provided a computer-implemented method for identifying objects in an environment, the method comprising:
receiving image data representing the environment from one or more cameras;
analysing the image data to detect objects in the environment and for each detected object, assigning a preliminary identification label and confidence factor to the object;
receiving environmental data from one or more environmental sensors, analysing the environmental data to detect classification indicators and for each detected object, adjusting the confidence factor assigned to the object if a classification indicator correlates with the preliminary identification label and/or using one or more measurement sensors to measure one or more physical characteristics relating to a set of objects at a predefined location within the environment, the set of objects being included within the detected objects, and, for each measured physical characteristic, adjusting the confidence factor associated with each object in the set if the physical characteristic corresponds to an expected value for the objects found at the predefined location; and
for each detected object, identifying the object by associating with it a final identification label equal to the preliminary identification label if the confidence factor assigned to the object meets a predefined criterion.

The invention makes a preliminary identification of objects in the environment using image data and assigns a confidence factor for that identification to each detected object. In other words, the confidence factor indicates a degree of confidence with which the detected object is an object of a type indicated by the assigned preliminary identification label. By using environmental data and/or measurement of one or more physical characteristics of the detected objects, the system looks for clues that enable it to modify (for example, by increasing) its confidence in the preliminary identification label assigned from the image data. This improves the reliability of identification of objects and the abovementioned problem of not being able to identify objects within an environment to an adequate degree of confidence to reliably identify them for certain applications is therefore overcome by the invention.

It may be helpful to provide a simple example to elaborate on the explanation of the benefits of the invention discussed in the immediately preceding paragraph. In this simple example, the environment may include a surgical instrument such as a scalpel located on a tabletop, the weight of which is monitored by a suitable sensor (thereby providing a measurement of a physical characteristic of the scalpel on the tabletop). An omnidirectional microphone may gather audio data (the environmental data) whilst a camera provides image data representing the environment including the tabletop and surgical instruments. The analysis of the image data may lead to the assignment of a preliminary identification label of “SCALPEL” to the detected object on the tabletop (which is indeed a scalpel in this example) and a confidence factor which is below a threshold value (exceeding the threshold value being the predefined criterion). The confidence factor may be low, for example, if a dressing is obscuring part of the handle of the scalpel. By analysing the audio data using a speech recognition process, if the word “scalpel” is recognised, the confidence factor may be modified such that it increases. In addition, if the weight monitored by the sensor indicates that the weight of the objects on the tabletop are consistent with the expected weight of a scalpel, the confidence factor may be modified again such that it increases further. If these increases cause the confidence factor to exceed the threshold, the final identification label of “SCALPEL” may be assigned to the object.

The identification label may be a text string that is unique to an object or type of object. The text string may indicate the name of the object or type of object. Alternatively, the identification label may be a unique identifier (such as a numeric identifier) for an object or type of object. The unique identifier may be associated with a text string indicating the name (or other human-readable indication) of the object or type of object.

The confidence factor may be a number between 0 and 1. The confidence factor may be calculated by determining a correlation between a detected object and a reference object associated with the preliminary identification label. The correlation may be determined between the shape of the detected object and the shape of the reference object. The correlation may be determined between the shape of a boundary of the detected object and the shape of a boundary of the reference object.

A confidence factor may also be calculated for the correlation between a detected classification indicator and the preliminary identification label. The correlation between the detected classification indicator and the preliminary identification label may be determined from the similarity between the detected classification indicator and a reference classification indicator associated with the preliminary identification label.

A confidence factor may also be calculated for the correlation between a measured physical characteristic and an expected value. The correlation between the measured physical characteristic and the expected value may be determined from the ratio of the measured physical value to the expected value (or vice-versa).

Modifying the confidence factor may comprise increasing the confidence factor. Modifying the confidence factor may comprise averaging the confidence factor with a confidence factor for a correlation between a detected classification indicator and the preliminary identification label and/or a correlation between a measured physical characteristic and the expected value.

The one or more cameras may comprise an array of cameras, each of which is arranged to capture image data of the environment from a respective viewing angle. Typically, the array of cameras comprises two or three cameras.

This increases the chances of a clear view of the environment and the objects within it. For example, if the view from one camera is partially or entirely obscured, it may be unobscured from another camera. Similarly, if an object is partially obscured by another object from the viewpoint of one camera, it may be unobscured from the viewpoint of another camera.

The one or more physical characteristics may include the weight of the set of objects at the predefined location and the expected value is equal to the sum of the weights of each object in the set of objects.

Other physical characteristics that may be included within the one or more physical characteristics are heat emitted by an object or a portion of an object (which may be measured, for example, using a thermal imaging camera to detect the intensity of infrared light emitted), electrical resistance (for example, a resistor of a specific value associated with an object may be integrated with or affixed to the object and be measurable by a sensor that makes electrical contact with the resistor when the object is in a specific location), colour (for example, of an object itself, of a portion of an object, or of a coloured marker on or affixed to an object), a light emitter affixed to or integrated with an object that emits light of a particular wavelength (either visible or infrared), or size of an object or a portion of an object.

The set of objects may include only one object or it may include a plurality of objects, which may be the same or different objects.

The predefined location may be a tabletop, a workbench or a workstation. In the circumstance where the environment being monitored is an operating theatre (or a part thereof), the predefined location may be a tray on which one or more surgical instruments are located.

The one or more measurement sensors may include a weight sensor (for example, a strain gauge), a resistance sensor or a sensor for detecting the colour or wavelength of light (either visible or infrared).

The environmental data may be non-image data.

The environmental data may be audio data and the classification indicators are utterances detected in the audio data. In this case, the one or more environmental sensors may include a microphone such as an omnidirectional microphone.

In another example, the one or more environmental sensors may include a photoelectric proximity sensor. This may detect ambient light in the environment unless the sensor is covered. The environmental data in this case may be a measurement of ambient light levels which will be disturbed at the position of the sensor if this is covered. If the sensor is located in a position associated with the usual storage of an object, the lack of light in this position may indicate the presence of the object.

A classification indicator may be determined to correlate with the preliminary identification label if:
a) an utterance detected in the audio data is the same as the preliminary identification label;
b) an utterance detected in the audio data is the same as a portion of the preliminary identification label, a portion of the utterance detected in the audio data is the same as the preliminary identification label, or a portion of the utterance detected in the audio data is the same as a portion of the preliminary identification label; or
c) an utterance detected in the audio data is associated with a category of item to which the detected object to which the preliminary identification label has been assigned belongs.

The method may be carried out in response to detection of a change in one or more of the measured physical characteristics. This could be done for an initial execution of the method or for a subsequent execution or for both initial and subsequent executions. However, it is particularly beneficial to use detection of a change in one or more of the measured physical characteristics to trigger a subsequent execution of the method after a steady state has been reached in the environment as this can indicate that something has changed. For example, if in an operating theatre a set of surgical instruments has been placed at the predefined location (e.g. a tray of which the weight is measured), then an initial execution of the method could be performed to analyse the steady state situation (i.e. the objects initially present at the predefined location) and then a subsequent execution could be performed when the weight (or other physical characteristic) changes, indicating the likelihood of the removal of an object from the predefined location or addition of a new object to the predefined location.

The method may be carried out in response to detection of a change in the image data. For example, detection of a significant change in the image data between successive frames or detection of a specific entity in the image data (for example, a user's hand or hands) may trigger either the initial or subsequent execution of the method.

Analysing the image data may comprise a shape sensing algorithm for sensing shapes of predefined features of objects in the environment, a particular object being detected if a shape of a feature sensed by the algorithm corresponds to the shape of the feature of the particular object in a database of objects.

The shape sensing algorithm may use a variety of techniques. However, it is particularly advantageous to use a machine learning or artificial intelligence algorithm that has been trained to detect objects of interest in a particular application (for example, goods in an assembly line at a manufacturing unit, boxes in a packaging facility or surgical instruments in an operating theatre).

Each of one or more of the shapes in the database of objects may be associated with a respective state classification for the particular object to which it corresponds, the state classification indicating the state of the particular object.

The state classification may, for example, indicate if an object is switched on or off, open or closed or whether it has been used. This is because objects may have different shapes in different states. For example, an object such as a pair of scissors will have a different shape when open to when closed, and an object with a power switch or similar will have a different shape when the switch is in different positions. By associating each of these different shapes with a respective state classification, the method can detect the different states of an object that it has detected. Thus, any state of an object can be detected in this way when that state has a distinct shape.

The method may further comprise associating a state classification which indicates that the particular object is cracked or broken if a bright or dark region is detected from the image data within the shape sensed by the algorithm.

The detection of cracked or broken objects is possible because the crack will either appear brighter than the rest of the object if light is visible through the crack or darker than the rest of the object if the crack is predominantly illuminated from the same side as the or each camera views the object.

The predefined criterion may be that the confidence factor exceeds a predefined threshold.

Each detected object having an assigned confidence factor below the predefined threshold may be classified as an unknown object or an object of no interest.

The method may further comprise creating a data structure comprising a list of the identified objects.

The data structure may include a field for storing a count of identified objects which are associated with the same final identification label, each instance of such an identified object being associated with a respective distinguishing marker in the data structure.

For each identified object, the data structure may include a presence flag associated with the identified object to indicate the detected presence or absence of the identified object in the environment.

The list of identified objects, the count of identified objects and/or the presence flag associated with each of the identified objects may be displayed on a display device. The display device may include a touch screen and/or a microphone for receiving user input. The display device may also comprise a head-mounted augmented reality device.

The method may further comprise receiving data defining a first list of objects, and comparing the first list of objects with the list of identified objects in the data structure. Thus, there is provided a way of accounting for the presence or absence of items used in a procedure. The data defining the first list of objects may be entered by a user prior to carrying out a procedure or it may already be stored in a storage device.

In accordance with a second aspect of the invention, there is provided a computer-implemented method for accounting for the presence or absence of items used in a procedure, the method comprising carrying out the method according to the first aspect of the invention prior to the procedure, creating a first list of identified objects prior to the procedure, repeating the method according to the first aspect of the invention during and/or after the procedure, creating a second list of identified objects after the procedure, comparing the first list to the second list and generating an alert if the second list differs from the first list. The second list may be created in real-time by updating the first list.

The second aspect of the invention therefore solves the abovementioned problem of accounting for items used in a procedure to ensure that none go missing during the procedure or do not get used appropriately during a procedure. In terms of the specific example of vehicle maintenance given above, this method enables accounting for the components used in the vehicle maintenance procedure and/or for components removed from the vehicle during the procedure which must be refitted before the end of the procedure. In addition, it can be used to ensure the presence of an inventory of objects (such as tools, instruments and/or components) needed for a task.

With respect to the surgical operation example given above, the method enables accounting for all surgical instruments, dressings and other items used in a surgical operation to ensure that they are present at the end of the operation so that nothing is left in a patient.

The method may further comprise detecting the presence or absence of each identified object in the environment and inferring a stage of a procedure based on the presence or absence of each identified object. For example, if it is known that at a particular stage of a procedure an associated set of objects (which may be objects used in the procedure such as surgical instruments and/or components of an item on which the procedure is performed) must be present then comparison of a first list of the identified objects actually present with the a second list of the associated set of objects may indicate that the stage of the procedure has been reached if the comparison shows the first and second lists to be the same.

The method may further comprise indicating to the user an object which is needed at a stage in the procedure which is next following the inferred stage. This may be done by referring to a lookup table which associates inferred stages with the objects needed in the next stage.

The method may further comprise issuing an alert if an identified object is absent from the environment during the inferred stage of the procedure when it is expected or if an identified object is present in the environment during a stage of a procedure when it is not expected.

The method may further comprise determining whether an event has occurred or is expected to occur by detecting the presence or absence of each identified object in the environment, creating a register indicating the presence or absence of each identified object, comparing the register with a set of lists of objects, each of which is associated with a respective event, and determining that an event has occurred or is expected to occur if the register matches the list of objects associated with the event.

The event may trigger an alarm, or it may cause a notification of the occurrence or expected occurrence of the event to be given to a user.

The method may further comprise detecting the location of each identified object and optionally tracking movement of each identified object.

The location of the object may be provided in the form of co-ordinates within the image data.

The method may further comprise capturing a thermal signature for an identified object from a thermal sensor, comparing the thermal signature with a database of reference thermal signatures, and if the thermal signature matches one of the reference thermal signatures, associating a state classification associated with the matched reference thermal signature with the identified object.

The thermal sensor may be a thermal camera. The state classification associated with the thermal signatures may indicate that an object is wet or dry or what material it is made of. This is because objects have different thermal signatures when wet or dry (especially where the liquid that has wet the object is at a different temperature than ambient) and because different materials (e.g. cotton and steel) have different thermal signatures.

The association of a state classification with an identified object may provide an enhanced confidence that a detected object is of a type corresponding to the preliminary identification label. In such a case, the confidence factor may be modified as a result.

The method further comprising scanning the environment for barcode data, comparing each barcode in the barcode data with a database of reference barcodes, each of which is associated with a type of object, and, for each detected object, modifying the confidence factor if a barcode in the barcode data matches a reference barcode that is associated with a type of object that is of the same type as the detected object.

The barcode data may be scanned from the image data. Alternatively, it may be scanned using a dedicated barcode scanner coupled to the system. Barcodes may be scanned directly from detected objects to which they may be applied either on a label, by direct marking or by engraving. Alternatively, the barcode data may be present in a separate location (either within the environment or outside it when a dedicated barcode scanner is used) such as a sheet of paper on which the barcodes are present. The barcodes may be a conventional barcode or a QR code or any other kind of barcode.

In accordance with a third aspect of the invention, there is provided a system for identifying objects in an environment, the system comprising a processor coupled to a memory storing instructions, one or more cameras, one or more environmental sensors and/or one or more measurement sensors, each of the cameras and sensors being operatively linked to the processor, wherein the instructions, when executed on the processor, cause the processor to carry out the method of the first or second aspect of the invention.

In accordance with a fourth aspect of the invention, there is provided a computer readable medium storing instructions to be executed by a processor forming part of a system for identifying objects in an environment, the system comprising one or more cameras, one or more environmental sensors and/or one or more measurement sensors, each of the cameras and sensors being operatively linked to the processor, wherein the instructions, when executed on the processor, cause the processor to carry out the method of the first or second aspect of the invention.

### BRIEF DESCRIPTION OF THE FIGURES

Embodiments of the invention will now be described with reference to the accompanying figures in which:

FIG. 1 shows a system for identifying objects in an operating theatre and for accounting for the presence or absence of items used in a procedure.

FIG. 2 shows a schematic view of the hardware used in the system of FIG. 1.

FIG. 3 shows a flowchart of the method employed in the embodiment of FIGS. 1 to 3.

FIG. 4 shows the surgical instruments on a tray used in the operating theatre of FIG. 1 before and after removal of an instrument.

### DETAILED DESCRIPTION

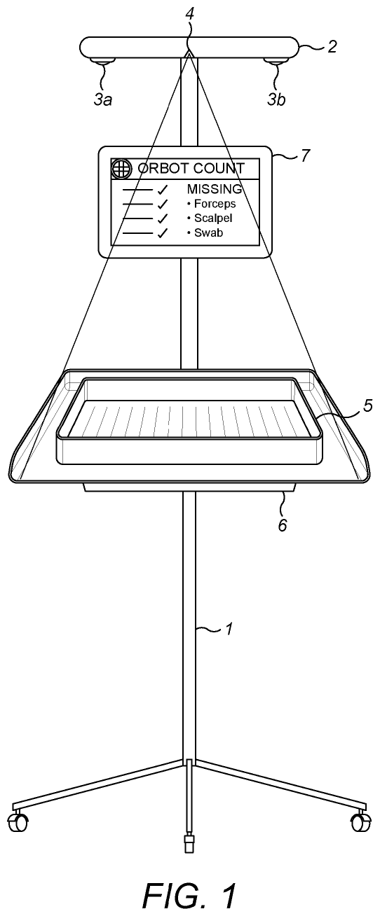

FIG. 1 shows a system for use in an operating theatre. The system is able to carry out methods for identifying objects used in the operating theatre and for accounting for the presence or absence of items used in a surgical procedure performed in the operating theatre.

The system comprises a stand 1. At the top of the stand 1 is a housing 2 containing an array of two cameras 3a, 3b (in other embodiments, more than two cameras may be used) and a light 4. The light 4 is an anti-glare light that illuminates a tray 5 underneath. In other embodiments, there may be more than one light, for example one for each camera 3a, 3b.

The tray 5 is used to hold surgical instruments for use in the surgical procedure. The two cameras 3a, 3b each gather image data representing the environment within the operating theatre, including in particular the tray 5 and the surgical instruments placed upon it, from a respective viewpoint. The tray 5 is supported on a tabletop 6 in which is integrated a strain gauge 8 that measures the weight of the tray and the surgical instruments within it. The weight of the tray 5 will usually be tared so that it does not affect the measured weight of the instruments on the tray.

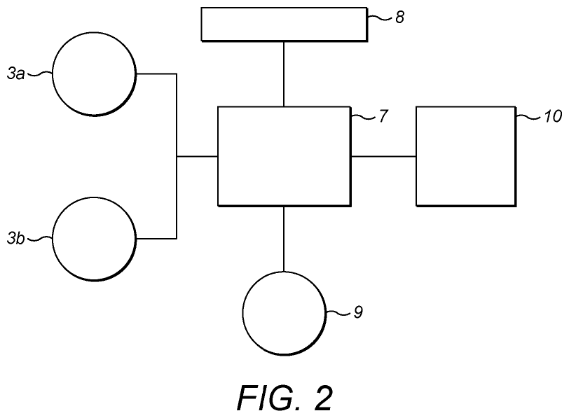

A computer 7 is coupled to each of the cameras 3a, 3b to receive image data from them and to the strain gauge 8 to receive a signal representing the weight of the tray 5 and the surgical instruments placed upon it. This is shown schematically in FIG. 2. The computer 7 may also optionally be coupled to a switch for controlling the supply of power to the light 4, or the light may be powered at all times when the system is powered. In addition, the computer system may be coupled to an omnidirectional microphone 9 (in other embodiments, more than one omnidirectional microphone may be used) which may be integrated within the same housing as the computer system 7. Alternatively, the omnidirectional microphone 9 may be integrated in housing 2. The computer system 7 is provided with a touchscreen interface 10 for displaying information to users and for receiving user input from them. The touchscreen interface 10 is also integrated within the same housing as the computer system 7.

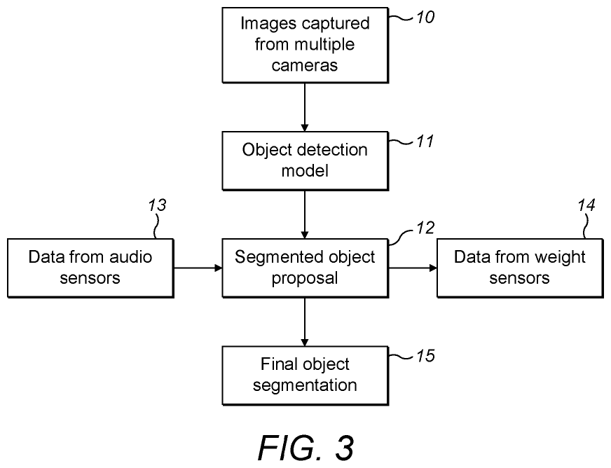

FIG. 3 shows a flowchart of the method for identifying objects carried out by the system shown in FIG. 1. In FIG. 3, step 10 shows the two cameras 3a, 3b capture image data representing different views including the tray 5 and any surgical instruments upon it from their respective viewpoints. The use of two different viewpoints improves the capability to detect an object that is occluded or obscured (either partially or completely) from one viewpoint when it is not from the other.

In step 11, an object detection algorithm is run. In this embodiment, the algorithm is a machine learning algorithm that has already been trained to detect and identify objects in the image data provided by the two cameras 3a, 3b. The object detection algorithm segments the image into regions, in each of which an object is detected. Each detected object is assigned a preliminary identification label along with a confidence factor which represents the degree of confidence that the machine learning algorithm has in the preliminary identification label that has been assigned being accurate. This segmentation of the image data and assignment of preliminary identification label and confidence factor forms the segmented object proposals indicated in step 12. It represents a preliminary identification of the objects visible in the image data from that data alone.

A suitable object detection algorithm for use in step 11 can be based on the Mask R-CNN framework which can be trained with the assistance of the TensorFlow software library. Details of the Mask R-CNN framework are provided in the paper entitled “Mask R-CNN” by Kaiming He, Georgia Gkioxari, Piotr Dollár and Ross Girshick which is available at https://arxiv.org/abs/1703.06870.

It is necessary to train the object detection model used in step 11 in order to learn specific features that distinguish one instrument from the other. To train the model, a large number of images of objects on which the object boundaries have been drawn is used. The object boundaries are associated with the names of the object they surround. These images are provided to the Mask R-CNN deep learning framework along with the associated names and object boundaries to train the algorithm. When trained, the model will detect boundaries of objects in7 image data along with the name (or label) assigned to each object for which a boundary has been detected. It will also calculate a confidence factor. The confidence factor is calculated by determining the correlation between the boundary that has been detected for an object and a reference boundary for objects of that type.

Steps 11 and 12 are performed on the image data from each of the two cameras 3a, 3b. As both the cameras 3a, 3b capture image data representing a view of the same objects from different viewpoints, it is anticipated that generally the results of the object detection algorithm and the segmented object proposals of steps 11 and 12 should be the same for each camera 3a, 3b. However, this will not be the case where an object is hidden in the viewpoint of one of the cameras 3a, 3b. The use of two cameras is intended to help solve this problem. Where there is no difference between the objects visible from each camera 3a, 3b, then the results of steps 11 and 12 from one camera will simply confirm those from the other. Alternatively, if an object is visible or detectable from the viewpoint of one camera but not from the other, the results of steps 11 and 12 from each camera can be combined to include all the objects visible or detectable from each of the two cameras 3a, 3b. Thus, the processing of image data from the two cameras 3a, 3b enables the system to form a consensus of the objects to be identified based on what is visible from different viewpoints.

In an ideal scenario, steps 11 and 12 should detect each object of interest visible to cameras 3a, 3b correctly. However, there are various problems that prevent this from happening with perfect reliability. For example, perspective deformation of an object owing to its viewpoint from a camera might cause it not to be recognised by the object detection algorithm. Other problems are poor illumination, slight differences between the shape of objects of the same type, occlusion of an object (as mentioned above) and difficulty distinguishing the object from the background. These issues can cause an object not to be detected or to be wrongly identified by the object detection algorithm.

For this reason, the detection and identification using the object detection model 11 resulting in the segmented object proposals 12 are refined using audio data from omnidirectional microphone 9 and weight data from the strain gauge 8.

The audio data from omnidirectional microphone 9 is used as the input to an automatic speech recognition algorithm running on the computer system 7. This is shown at step 13. A suitable algorithm is based on the wav2vec algorithm which uses unsupervised pre-training of a multi-layer convolutional neural network for speech recognition. Details of the algorithm can be found in the paper entitled “wav2vec: Unsupervised Pre-training for Speech Recognition” by Steffen Schneider, Alexei Baevski, Ronan Collobert and Michael Auli which is available at https://arxiv.org/abs/1904.05862.

Using this algorithm, speech present in the audio data can be recognised to detect utterances that correlate with objects of interest in the specific application. For example, in the application of surgery, a clinician might call out the name of a certain instrument, for example “retractor” or “scalpel”, and the speech recognition algorithm can detect these utterances and use them to refine the identification based on the image data described above.

In addition, data from the strain gauge 8 is used to refine the segmented object proposals 12. The set of objects detected as the output of the segmented object proposals 12 will have an expected weight value. The measured weight value can be provided to the computer system 7 and used to refine the segmented object proposals 12 if the measured weight value corresponds to the expected weight value for the set of objects.

Image data from the cameras 3a, 3b can be captured continuously or periodically. Alternatively, it can be triggered by a change in measured weight value. Thus, the system is purely reactive to certain changes in what is in the tray 5 when there is a high likelihood of a change in the objects present on it.

From the description above, it can be seen that detection and identification of objects happens in two phases. In the first phase, the cameras 3a, 3b are used to make a preliminary identification which is assigned to each detected object along with a confidence factor. If the confidence factor is below a threshold then the object cannot be adequately identified based on image data from the cameras 3a, 3b alone. The threshold may be a confidence factor of 0.95. As mentioned above, the confidence factor is calculated by determining the correlation between the detected object and a reference object of that type.

Further information from the strain gauge 8 and omnidirectional microphone 9 are used in a second stage to refine the identification. For example, if an objected detected in the image data from each of cameras 3a and 3b is identified as a scalpel with a confidence factor of 0.93, this will not exceed the threshold. However, if the change of weight detected by strain gauge 8 corresponds to that of a scalpel (or the measured weight of the set of objects on the tray 5 corresponds to an expected weight value for such a set of objects) with a confidence factor of 0.97 this can be used to refine the identification. Similarly, if the audio data from omnidirectional microphone 9 is detected to include the utterance “scalpel” with a confidence factor of 0.99, this can also be used to refine the identification. Again, the confidence factors for the weight value and the utterance are calculated by determining the correlation between the weight value or utterance and a reference weight value for an object of that type or a reference utterance associated with an object of that type. Then the confidence factor can be modified to form an average of (0.93+0.93+0.97+0.99)/4=0.96. Since this exceeds the threshold, the identification of a scalpel can be confirmed.

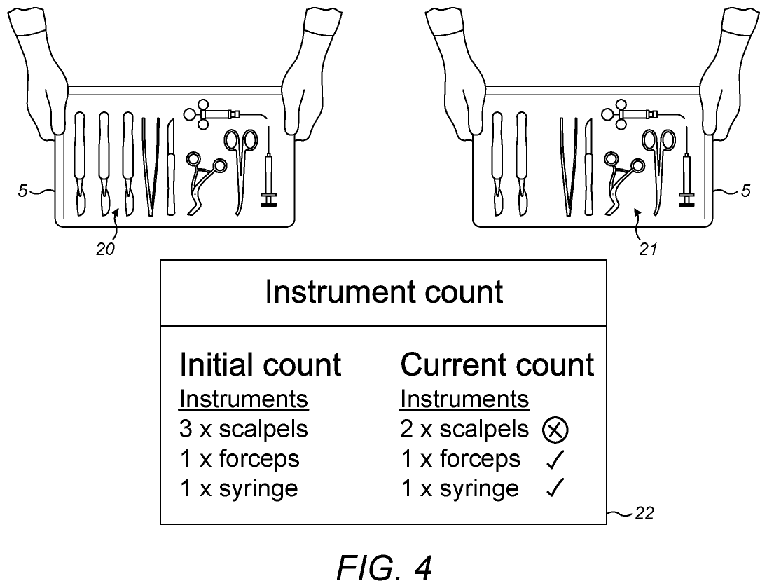

FIG. 4 shows an initial layout 20 of various surgical instruments on the tray 5 and a subsequent layout 21 of surgical instruments after a scalpel has been removed. The information shown on touchscreen interface 10 after the scalpel is removed is shown at 22. The general operation of the system shown in FIG. 1 will now be described with reference to FIG. 4.

Initially, the touchscreen interface 10 shows the views of the two cameras 3a, 3b. The operator can adjust the cameras 3a, 3b to ensure that the tray 5 is in the field of vision of each camera. The objects on the tray 5 in the initial configuration 20 instances are then detected and identified as explained above and the frequency of each object is displayed on the touchscreen interface 22 in a tabular form as shown on the right-hand side at 22. The weight of the tray 5 and instruments as measured by strain gauge 8 may also be displayed.

A scalpel is then removed from the tray 5. The removal will cause a change in weight on the tray which will trigger the system to run the method shown in FIG. 2 again. The system will then detect a different set of objects (the original set shown in the initial configuration 20 minus the scalpel). The removal of the scalpel can be corroborated by the change in weight equalling that of a scalpel, the measured weight of the set of objects shown in subsequent configuration 21 equalling the expected weight and the possible utterance of the word “scalpel” as detected by the omnidirectional microphone 9. The computer system 7 then adjusts the current count of instruments shown on the left-hand side at 22 to indicate the missing scalpel.

In this way, the system provides a method for accounting for the presence or absence of items used in the surgical procedure. In the example of FIG. 4, an initial count of instruments is made (as shown at the left-hand side at 22). The removal of the scalpel causes the object detection and identification process to be carried out again, creating a subsequent count of objects on the tray. By comparing these two counts, it is possible for the computer system 7 to detect the missing scalpel and generating an alert if it is not replaced. The alert may be a simple visual indication (as shown by the cross on the left-hand side at 22, for example) or it may be an audible alarm.

The audible alarm may be issued after a certain time period has elapsed after removal of the scalpel or other item if it is not replaced during that time period.

It is also possible to infer the stage of a procedure such as a surgical procedure by detecting the presence or absence of each identified object and inferring the stage of the procedure based on the presence or absence of each identified object. For example, if a special instrument is needed in a procedure and is removed from the tray 5, it can be inferred that the stage of the procedure when that instrument is to be used has been reached. Similarly, if it is known that a particular configuration of instruments or items will be used by a particular stage of a procedure, the absence (or potentially removal and subsequent replacement) of those instruments or items indicates that the particular stage has been reached.

By monitoring the usage of instruments or items, it is also possible to detect which instruments are actually used during a specific procedure. This information can be used to optimise the instrumentation or items made available for performing that procedure in future.

Although the system and method described with reference to FIGS. 1 to 4 relates to a surgical operating theatre application, the skilled person will realise that the system and method are applicable to other scenarios. Other possible applications, such as the use of the method and system for vehicle maintenance, have already been explained above. Another example could include identifying the objects packed in a parcel to fulfil an order placed by a customer so that correct packing of all the objects ordered can be ensured. The system may also be used in staff training applications and in optimising the inventory of tools or instruments to be made available for a procedure.

1. A computer-implemented method for identifying objects in an environment, the method comprising:
receiving image data representing the environment from one or more cameras; analysing the image data to detect objects in the environment and for each detected object, assigning a preliminary identification label and confidence factor to the object;
receiving environmental data from one or more environmental sensors, analysing the environmental data to detect classification indicators and for each detected object, adjusting the confidence factor assigned to the object if a classification indicator correlates with the preliminary identification label and/or using one or more measurement sensors to measure one or more physical characteristics relating to a set of objects at a predefined location within the environment, the set of objects being included within the detected objects, and, for each measured physical characteristic, adjusting the confidence factor associated with each object in the set if the physical characteristic corresponds to an expected value for the objects found at the predefined location; and
for each detected object, identifying the object by associating with it a final identification label equal to the preliminary identification label if the confidence factor assigned to the object meets a predefined criterion.

2. The method of claim 1, wherein the one or more cameras comprise an array of cameras, each of which is arranged to capture image data of the environment from a respective viewing angle.

3. The method of claim 1, wherein the one or more physical characteristics includes the weight of the set of objects at the predefined location and the expected value is equal to the sum of the weights of each object in the set of objects.

4. The method of claim 1, wherein the environmental data is audio data and the classification indicators are utterances detected in the audio data.

5. The method of claim 4, wherein a classification indicator correlates with the preliminary identification label if:
a) an utterance detected in the audio data is the same as the preliminary identification label;
b) an utterance detected in the audio data is the same as a portion of the preliminary identification label, a portion of the utterance detected in the audio data is the same as the preliminary identification label, or a portion of the utterance detected in the audio data is the same as a portion of the preliminary identification label; or
c) an utterance detected in the audio data is associated with a category of item to which the detected object to which the preliminary identification label has been assigned belongs.

6. The method of claim 1, wherein the method is carried out in response to detection of a change in one or more of the measured physical characteristics.

7. The method of claim 1, wherein analysing the image data comprises a shape sensing algorithm for sensing shapes of objects in the environment, a particular object being detected if a shape sensed by the algorithm corresponds to the shape of the particular object in a database of objects.

8. The method of claim 7, wherein each of one or more of the shapes in the database of objects is associated with a respective state classification for the particular object to which it corresponds, the state classification indicating the state of the particular object.

9. The method of claim 7, further comprising associating a state classification which indicates that the particular object is cracked or broken if a bright or dark region is detected from the image data within the shape sensed by the algorithm.

10. The method of claim 1, wherein the predefined criterion that the confidence factor exceeds a predefined threshold.

11. The method of claim 9, wherein each detected object having an assigned confidence factor below the predefined threshold is classified as an object of no interest.

12. The method of claim 1, further comprising creating a data structure comprising a list of the identified objects.

13. The method of claim 12, wherein the data structure includes a field for storing a count of identified objects which are associated with the same final identification label, each instance of such an identified object being associated with a respective distinguishing marker in the data structure.

14. The method of claim 12, wherein, for each identified object, the data structure includes a presence flag associated with the identified object to indicate the detected presence or absence of the identified object in the environment.

15. The method of claim 12, further comprising receiving data defining a first list of objects, and comparing the list of objects with the list of identified objects in the data structure.

16. A computer-implemented method for accounting for the presence or absence of items used in a procedure, the method comprising carrying out the method according to any of the preceding claims prior to the procedure, creating a first list of identified objects prior to the procedure, repeating the method according to any of the preceding claims during and/or after the procedure, creating a second list of identified objects after the procedure, comparing the first list to the second list and generating an alert if the second list differs from the first list.

17. The method of claim 16, further comprising detecting the presence or absence of each identified object in the environment and inferring a stage of a procedure based on the presence or absence of each identified object.

18. The method of claim 17, further comprising issuing an alert if an identified object is absent from the environment during the inferred stage of the procedure when it is expected or if an identified object is present in the environment during a stage of a procedure when it is not expected.

19. The method of claim 16, further comprising determining whether an event has occurred or is expected to occur by detecting the presence or absence of each identified object in the environment, creating a register indicating the presence or absence of each identified object, comparing the register with a set of lists of objects, each of which is associated with a respective event, and determining that an event has occurred or is expected to occur if the register matches the list of objects associated with the event.

20. The method of claim 16, further comprising detecting the location of each identified object and optionally tracking movement of each identified object.

21. The method of claim 16, further comprising capturing a thermal signature for an identified object from a thermal sensor, comparing the thermal signature with a database of reference thermal signatures, and if the thermal signature matches one of the reference thermal signatures, associating a state classification associated with the matched reference thermal signature with the identified object.

22. The method claim 16, further comprising scanning the environment for barcode data, comparing each barcode in the barcode data with a database of reference barcodes, each of which is associated with a type of object, and, for each detected object, modifying the confidence factor if a barcode in the barcode data matches a reference barcode that is associated with a type of object that is of the same type as the detected object.

23. A system for identifying objects in an environment, the system comprising a processor coupled to a memory storing instructions, one or more cameras, one or more environmental sensors and/or one or more measurement sensors, each of the cameras and sensors being operatively linked to the processor, wherein the instructions, when executed on the processor, cause the processor to carry out the method of any of the preceding claims.

24. A computer readable medium storing instructions to be executed by a processor forming part of a system for identifying objects in an environment, the system comprising one or more cameras, one or more environmental sensors and/or one or more measurement sensors, each of the cameras and sensors being operatively linked to the processor, wherein the instructions, when executed on the processor, cause the processor to carry out the method of claim 1.
